(19) United States
(12) Patent Application Publication
(10) Pub. No.: US 2009/0183221 A1
(43) Pub. Date: Jul. 16, 2009

(54) System and Method of Delivering Content Related to a Media Channel to a Wireless D

(75) Inventors: Adam Klein, Cedar Park, TX (US); James Austin Britt, Manor, TX (US); Joshua J. Fox, Austin, TX (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 12/013,749

(22) Filed: Jan. 14, 2008

(51) Int. Cl. H04N 7/173

(52) U.S. Cl. 725/131

(57) ABSTRACT

A method of delivering content related to a media channel to a wireless device is disclosed and includes receiving a request to access a web portal. The request is received from a wireless device at a portal server associated with a video distribution network. The method also includes receiving data at the portal server from a network element associated with the video distribution network, the data indicating a media channel associated with media content currently received at a set-top box device. The set-top box device and the wireless device are associated with a media service subscriber. Further, the method includes automatically sending content related to the media channel to the wireless device via the web portal, in response to the access request.

### FIELD OF THE DISCLOSURE

The present disclosure generally relates to communications networks, and more particularly relates to delivering content related to a media channel to a wireless device.

### BACKGROUND

Media service providers distribute a wide variety of media content. Customers may desire to enhance their viewing or listening experiences by receiving information and other content that is related to media content that they receive. Such customers must often interrupt their viewing or listening experiences in order to retrieve related content.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a particular embodiment of a system to deliver content related to a media channel to a wireless device;

FIG. 2 is a block diagram illustrating a second particular embodiment of a system to deliver content related to a media channel to a wireless device;

FIG. 3 is a block diagram illustrating a third particular embodiment of a system to deliver content related to a media channel to a wireless device;

FIG. 4 is a block diagram illustrating a fourth particular embodiment of a system to deliver content related to a media channel to a wireless device;

FIG. 5 is a block diagram illustrating a particular embodiment of a method of delivering content related to a media channel to a wireless device;

FIG. 6 is a block diagram illustrating a second particular embodiment of a method of delivering content related to a media channel to a wireless device;

FIG. 7 is a block diagram illustrating a third particular embodiment of a method of delivering content related to a media channel to a wireless device;

FIG. 8 is a block diagram illustrating a fourth particular embodiment of a method of delivering content related to a media channel to a wireless device; and

FIG. 9 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed systems, methods or computer-readable media. Moreover, some statements may apply to some inventive features but not to others.

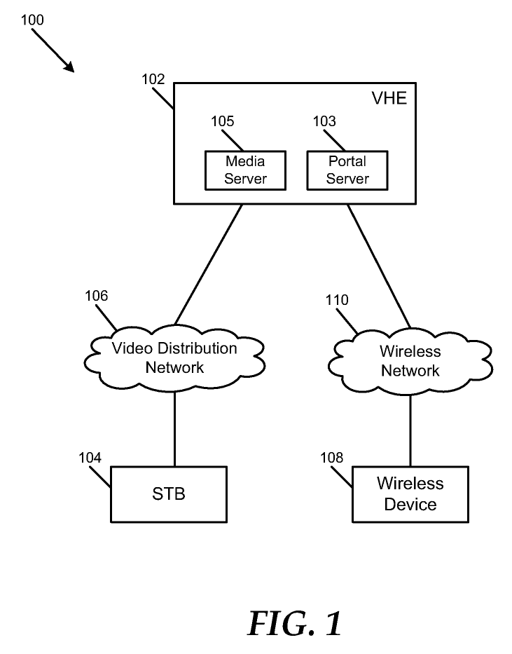

FIG. 1 illustrates a particular embodiment of a system 100 to deliver content related to a media channel to a wireless device. The system 100 includes a video head-end (VHE) 102 associated with a video distribution system, such as a cable system, satellite system, or an Internet protocol television (IPTV) system. The VHE 102 includes a plurality of network elements, such as a portal server 103, at least one media server such as the media server 105, and other servers. The VHE 102 communicates with a plurality of set-top box devices, such as the set-top box device (STB) 104, via a video distribution network 106. In one embodiment, the VHE 102 also communicates with a plurality of wireless devices, such as the wireless device 108, via at least one wireless network, such as the wireless network 110. In an illustrative embodiment, the wireless device 108 can include a web-enabled cellular phone communicating with the VHE 102 via a cellular network or Wi-Fi network.

In an illustrative embodiment, the set-top box device 104 and the wireless device 108 are associated with a subscriber to a media service, such as an IPTV service or other service. The set-top box device 104 is adapted to receive a channel selection from the subscriber or another user and to send a request to the VHE 102 for media content associated with the selected channel. The media server 105 is adapted to send the requested media content to the set-top box device 104. The set-top box device 104 is adapted to receive the requested media content, which may include audio, video, or a combination thereof, and to output the media content via a display device coupled to the set-top box device 104.

In addition, the subscriber or another user can send a request from the wireless device 108 to access a web portal that provides content related to media channels provided via the video distribution network 106. Content related to a media channel can include content related to the media channel itself, to media content associated with the media channel, or a combination thereof. The portal server 103 is adapted to receive a request from the wireless device 108 to access the web portal. The portal server 103 is also adapted to identify the wireless device 108 and the media service subscriber associated with the wireless device 108. Further, the portal server 103 is adapted to receive data from the media server 105 or another network element at the VHE 102 indicating a media channel associated with media content currently being sent to the set-top box device 104. The portal server 103 is adapted to automatically send content related to the media channel to the wireless device 108 in response to the request to access the web portal. Hence, the related content can be sent without a specific request from the subscriber or other user of the wireless device 108 for such content. The portal server 103 can retrieve the related content from memory at the portal server 103 or from one or more information servers or other network elements at the VHE 102.

Examples of content related to a media channel include suggestions of video programming, music or other media content; content related to a video program, song, collection of songs, or other media currently received at the set-top box device 104, such as credits; video-on-demand information related to media content being sent to the set-top box device 104; targeted advertising information, including (without limitation) links to purchase digital video discs (DVDs), digital music or other products related to the media content; historical content, such as content indicating programs and advertising previously provided to the set-top box device 104, the wireless device 108, or a combination thereof, during a period of time; real-time surveying content related to media content received at the set-top box device 104, such as a media content rating interface, a contestant voting interface, or other surveying content.

The wireless device 108 is adapted to display content related to a media channel associated with media content received at the set-top box device 104. Further, the wireless device 108 can be adapted to receive inputs related to interactive content displayed at the wireless device 108. For example, the content related to the media channel can include a contestant voting interface or DVD purchasing information, and the wireless device 108 can receive inputs to vote for a television program contestant or to purchase a DVD. The wireless device 108 is adapted to send data indicating such inputs to the VHE 102. The portal server 103 is adapted to process such data and send the processed data to one or more other network elements at the VHE 102. In one example, the data includes an interface to play along with a quiz show. The portal server 103 can receive data indicating a subscriber answer to a quiz show question and send data indicating the answer to another network element at the VHE 102. The set-top box device 104 can receive information content related to the processed data, such as information indicating the answer, and the answer can be displayed together with video content related to the quiz show at the display device coupled to the set-top box device 104.

In one embodiment, the wireless device 108 is adapted to receive additional content related to the media channel associated with media content received at the set-top box device 104, or content related to a new channel to which the set-top box device 104 has been tuned. For example, the set-top box device 104 can receive a channel change command and send a new channel selection to the VHE 102. The portal server 103 is adapted to receive data indicating the new channel selection and to send new content related to the new channel to the wireless device 108 via the web portal. The portal server 103 can receive data indicating the new channel from the media server 105, from another media server associated with the new channel, or from another network element at the VHE 102. The wireless device 108 is adapted to refresh its display to display the new content in place of, or together with, the content related to a previous media channel.

In another embodiment, the content sent by the portal server 103 to the wireless device 108 can suggest programming associated with another channel and can include a selectable indicator of an option to receive the programming at the set-top box device 104. The portal server 103 can be adapted to receive a selection of the indicator and to send data indicating the selection of the indicator to another network element at the VHE 102, such as a media server associated with the other channel. The media server 105 or another media server can send programming associated with the other channel to the set-top box device 104, and the portal server 103 can send content related to the other channel to the wireless device 108.

During operation, the wireless device 108 and the set-top box device 104 can be located at a subscriber premise. Alternatively, the wireless device 108 can be located outside the subscriber premise, e.g., where the subscriber wishes to remotely monitor media content received at the set-top box device 104.

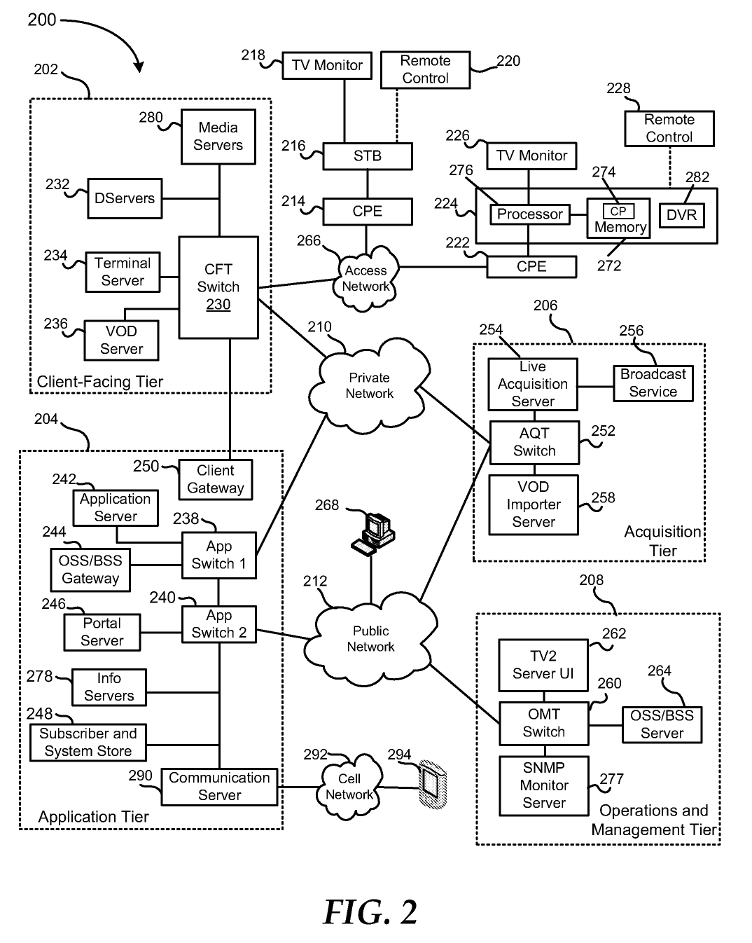

FIG. 2 illustrates a second particular embodiment of a system 200 to deliver content related to a media channel to a wireless device. The system 200 includes elements of an Internet protocol television (IPTV) system having a client facing tier 202, an application tier 204, an acquisition tier 206, and an operations and management tier 208. Each tier 202, 204, 206, and 208 is coupled to a private network 210, a public network 212, or both the private network 210 and the public network 212. For example, the client-facing tier 202 can be coupled to the private network 210, while the application tier 204 can be coupled to the private network 210 and to a public network, such as the Internet. The acquisition tier 206 can also be coupled to the private network 210 and to the public network 212. Moreover, the operations and management tier 208 can be coupled to the public network 212. In some alternative embodiments, the operations and management tier 208 can also be coupled to the private network 210.

The various tiers 202, 204, 206 and 208 communicate with each other via the private network 210 and the public network 212. For instance, the client-facing tier 202 can communicate with the application tier 204 and the acquisition tier 206 via the private network 210. The application tier 204 can also communicate with the acquisition tier 206 via the private network 210. Further, the application tier 204 can communicate with the acquisition tier 206 and the operations and management tier 208 via the public network 212. Moreover, the acquisition tier 206 can communicate with the operations and management tier 208 via the public network 212. In a particular embodiment, elements of the application tier 204 can communicate directly with the client-facing tier 202.

The client-facing tier 202 can communicate with user equipment via a private access network 266, such as an Internet Protocol Television (IPTV) access network. In an illustrative embodiment, customer premises equipment (CPE) such as a first CPE device 214 and a second CPE device 222 can be coupled to the private access network 266. The CPE devices 214 and 222 can include modems (e.g., digital subscriber line modems), residential gateways, routers, other devices, or any combination thereof. The client-facing tier 202 can communicate with a first representative set-top box (STB) device 216 via the first CPE device 214 and with a second representative set-top box device 224 via the second CPE device 222. The client-facing tier 202 can communicate with a large number of set-top boxes over a wide geographic area, such as a regional area, a metropolitan area, a viewing area, or any other suitable geographic area that can be supported by networking the client-facing tier 202 to numerous set-top box devices. In one embodiment, the client-facing tier 202 can be coupled to the CPE devices 214 and 222 via fiber optic cables. Alternatively, the CPE devices 214 and 222 can be digital subscriber line (DSL) modems that are coupled to one or more network nodes via twisted pairs, and the client-facing tier 202 can be coupled to the network nodes via fiber-optic cables. Each of the set-top box devices 216 and 224 can process data received from the private access network 266 via an IPTV software platform such as Microsoft® TV IPTV Edition.

The first set-top box device 216 can be coupled to a first display device 218, such as a first television monitor, and the second set-top box device 224 can be coupled to a second display device 226, such as a second television monitor. Moreover, the first set-top box device 216 can communicate with a first remote control 220, and the second set-top box device 224 can communicate with a second remote control 228. In an exemplary, non-limiting embodiment, each of the set-top box devices 216 and 224 can receive data or video from the client-facing tier 202 via the private access network 266 and render or display the data or video at the display device 218 or 226 to which it is coupled. In some embodiments, the set-top box devices 216 and 224 may include tuners that receive and decode television programming information for transmission to the display devices 218 and 226. Further, each of the set-top box devices 216 and 224 can include processing logic and memory accessible to the processing logic, such as the STB processor 276 and the STB memory device 272. Each STB memory device may include one or more computer programs, such as the computer program 274, that are executable by the STB processing logic. In one embodiment, one or more of the set-top box devices 216 and 224 may include integrated digital video recorder (DVR) devices or components, such as the DVR 282. In other embodiments, one or more of the set-top box devices 216 and 224 can be coupled to external DVR devices.

In an illustrative embodiment, the client-facing tier 202 can include a client-facing tier (CFT) switch 230 that manages communication between the client-facing tier 202 and the private access network 266, and between the client-facing tier 202 and the private network 210. As shown, the CFT switch 230 is coupled to one or more distribution servers (D-servers) 232 that may receive and store video content, channel selections, other data, or any combination thereof, which is bound to and from the set-top box devices 216 and 224. The CFT switch 230 can also be coupled to a terminal server 234 that provides terminal devices with a common connection point to the private network 210. In a particular embodiment, the CFT switch 230 can also be coupled to a video-on-demand (VOD) server 236.

Further, the CFT switch 230 is coupled to a plurality of media servers 280 that store video content or other media content that is to be distributed via the access network 266 in response to requests from the set-top box devices 216 and 224. In an illustrative, non-limiting embodiment, each of the media servers 280 can be associated with one or more media channels (e.g., video channels, music channels, other audio channels, informational channels, or a combination thereof) provided via the access network 266.

The application tier 204 can communicate with both the private network 210 and the public network 212. In this embodiment, the application tier 204 can include a first application tier (APP) switch 238 and a second APP switch 240. The first APP switch 238 can be coupled to the second APP switch 240. The first APP switch 238 can be coupled to an application server 242 and to an OSS/BSS gateway 244. The application server 242 provides applications to the set-top box devices 216 and 224 via the private access network 266. Such applications enable the set-top box devices 216 and 224 to provide functions such as display, messaging, processing of IPTV data and VOD material, gaming functions, other functions, or any combination thereof. In a particular embodiment, the OSS/BSS gateway 244 includes operation systems and support (OSS) data, as well as billing systems and support (BSS) data.

The second APP switch 240 can be coupled to a portal server 246 that provides a web portal that authorized users can access via the public network 212. The web portal can provide users to account information, content related to media channels, other information, or any combination thereof. The second APP switch 240 can be coupled to a subscriber and system store 248 that includes account information, such as account information that is associated with users who access the system 200 via the private network 210 or the public network 212. Further, the second APP switch 240 can be coupled to one or more information servers 278 that are adapted to store content related to various media channels provided via the IPTV system. In addition, the second APP switch 240 can be coupled to a communication server 290 that facilitates communication between the IPTV system and wireless devices, such as the wireless device 294, via one or more wireless networks, such as the cellular network 292.

In a particular embodiment, the application tier 204 can also include a client gateway 250 that communicates data directly to the client-facing tier 202. In this embodiment, the client gateway 250 can be coupled directly to the CFT switch 230. The client gateway 250 can provide user access to the private network 210 and the tiers coupled thereto. For instance, the set-top box devices 216 and 224 can access the system via the private access network 266 using information received from the client gateway 250. The private access network 266 provides security for the private network 210. User devices can access the client gateway 250 via the private access network 266, and the client gateway 250 can allow such devices to access the private network 210 once the devices are authenticated or verified. Similarly, the client gateway 250 can prevent unauthorized devices, such as hacker computers or stolen set-top box devices, from accessing the private network 210 by denying access to these devices beyond the private access network 266.

In an illustrative embodiment, when the set-top box device 216 accesses the system 200 via the private access network 266, the client gateway 250 can verify subscriber information by communicating with the subscriber and system store 248 via the private network 210, the first APP switch 238 and the second APP switch 240. Further, the client gateway 250 can verify billing information and status by communicating with the OSS/BSS gateway 244 via the private network 210 and the first APP switch 238. The OSS/BSS gateway 244 can transmit a query across the first APP switch 238, to the second APP switch 240, and the second APP switch 240 can communicate the query across the public network 212 to the OSS/BSS server 264. After the client gateway 250 confirms subscriber and/or billing information, the client gateway 250 can allow the set-top box device 216 access to media content. If the client gateway 250 cannot verify subscriber information for the set-top box device 216, (e.g., it is connected to a different twisted pair), the client gateway 250 can deny transmissions to and from the set-top box device 216 beyond the private access network 266.

The acquisition tier 206 includes an acquisition tier (AQT) switch 252 that communicates with the private network 210. The AQT switch 252 can also communicate with the operations and management tier 208 via the public network 212. In a particular embodiment, the AQT switch 252 can be coupled to a live acquisition server 254 that receives television content, for example, from a broadcast service 256. Further, the AQT switch can be coupled to a video-on-demand importer server 258 that stores television content received at the acquisition tier 206 and communicates the stored content to the client-facing tier 202 via the private network 210.

The operations and management tier 208 can include an operations and management tier (OMT) switch 260 that conducts communication between the operations and management tier 208 and the public network 212. In the illustrated embodiment, the OMT switch 260 is coupled to a TV2 server 262 that is adapted to provide a TV2 user interface to user computers 268 via the public network 212, for example. Additionally, the OMT switch 260 can be coupled to an OSS/BSS server 264 and to a simple network management protocol (SNMP) monitor 277 that monitors network devices. In a particular embodiment, the OMT switch 260 can communicate with the AQT switch 252 via the public network 212.

In an illustrative embodiment, the wireless device 294 and a set-top box device, such as the second representative set-top box device 224, are associated with a subscriber to a media service such as an IPTV service. The set-top box device 224 is adapted to receive a channel selection from the subscriber or another user and to send a request to the client-facing tier 202 for media content associated with the selected channel. A media server 280, a D-server 232, a VOD server 236, or another network element, can send the requested media content to the set-top box device 224. The set-top box device 224 is adapted to receive the requested media content, which may include audio, video, or a combination thereof, and to output the media content via the television monitor 226.

In addition, the portal server 246 is adapted to receive a request from the wireless device 294 to access a web portal that provides content related to media channels, such as the media channel associated with the media content sent to the set-top box device 224. The portal server 246 is adapted to identify the wireless device 294 and the media service subscriber associated with the wireless device 294. For example, the portal server 246 can be adapted to receive caller identification information, an Internet protocol address, other identifying information, or any combination thereof, from the wireless device 294. The portal server 246 or other network element can be adapted to compare the identifying information with account information stored at the portal server 246 or at another network element, such as the subscriber and system store 248, the OSS/BSS server 264, or a Lightweight Directory Access Protocol (LDAP) database (not shown), in order to identify the subscriber. In another example, the portal server 246 can be adapted to receive login information from a user of the wireless device 294 and to identify the subscriber based on the login information. The portal server 246 can determine whether the subscriber is authorized to access the web portal based on information identifying the wireless device 294, login information, or a combination thereof.

The portal server 246 is adapted to receive data from a D-server 232, media server 280, the subscriber and system store 248, or another network element, indicating a media channel associated with media content currently being sent to the set-top box device 224. The portal server 246 can receive the data indicating the media channel in response to a request sent by the portal server 246 to the data source. In another embodiment, the source of the data can periodically inform the portal server 246 of media channels associated with media content provided to various set-top box devices, such as set-top box devices connected with the web portal.

The portal server 246 is adapted to automatically send content related to the media channel to the wireless device 294 in response to the request to access the web portal. Hence, the related content can be sent without a specific request from the subscriber or other user of the wireless device 294 for such content. The portal server 246 can retrieve the related content from memory or from one or more information servers 278. Examples of content related to a media channel include suggestions of video programming or other media content; content related to a video program, song, collection of songs, or other media currently received at the set-top box device 224; video-on-demand information related to the media currently received at the set-top box device 224; targeted advertising information, including (without limitation) links to purchase digital video discs (DVDs) or other products related to the media content; historical content, such as content indicating programs and advertising previously provided to the set-top box device 224, the wireless device 294, or a combination thereof, during a period of time; real-time surveying content related to media content received at the set-top box device 224, such as a content rating interface, a contestant voting interface, or other surveying content.

In one embodiment, related content (e.g., programming suggestions or targeted advertising) can be selected by the portal server 246 or another network element based on historical information associated with the subscriber, such as a viewing history, purchasing history, other historical information, or any combination thereof. The portal server 246 can be adapted to send the related content to the wireless device 294 via a wireless access protocol (WAP) or other protocol suitable for transmitting web-based data to wireless devices, such as cellular devices or other wireless devices.

The wireless device 294 is adapted to display content related to a media channel associated with media content received at the set-top box device 224. Further, the wireless device 294 can be adapted to receive inputs related to interactive content displayed at the wireless device 294. For example, the wireless device 294 can receive inputs to vote for a television program contestant or to purchase a DVD. The wireless device 294 is adapted to send data related to such inputs to the portal server 246. The portal server 246 is adapted to process such data and send the processed data to one or more other network elements. In one example, the data includes a vote for a television program contestant. The portal server 246 can aggregate the vote with other votes and send the aggregated votes to a media server 280, D-server 232 or other server distributing the television program. The set-top box device 224 can receive information content related to the processed data, such as information indicating the aggregated votes, and the aggregated votes can be displayed together with the television program at the television monitor 226.

In one embodiment, the wireless device 294 is adapted to receive additional content related to a media channel, or content related to a new media channel to which the set-top box device 224 has been tuned. For example, the set-top box device 224 can receive a channel change command. The set-top box device 224 is adapted to send a new channel selection to the D-servers 232, media servers 280, or other network element of the client-facing tier 202. Further, the portal server 246 is adapted to receive data indicating the new channel selection and to send new content related to the new channel to the wireless device 294 via the web portal. The wireless device 294 is adapted to refresh its display to display the new content in place of, or together with, the content related to media content previously received at the set-top box device 224.

In another embodiment, the content sent by the portal server 246 to the wireless device 294 can suggest programming associated with another channel and can include a selectable indicator of an option to receive the programming at the set-top box device 224. The portal server 246 can be adapted to receive a selection of the indicator and to send data indicating the selection of the indicator to a D-server 232, media server 280 (e.g., a media server associated with the other channel), the OSS/BSS gateway 244, or another network element. The network element can send the programming associated with the other channel to the set-top box device 224. Additionally, the portal server 246 can send content related to the other channel to the wireless device 294.

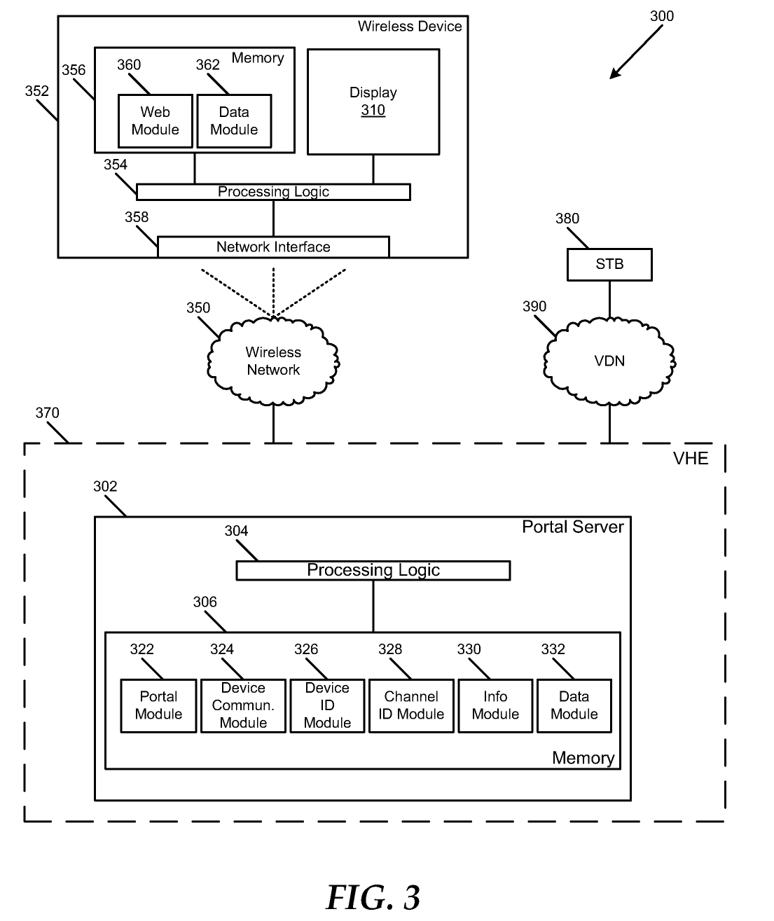

FIG. 3 illustrates a third particular embodiment of a system 300 to deliver content related to a media channel to a wireless device. The system 300 includes a portal server 302 associated with a video head-end (VHE) 370 of a video distribution system, such as the Internet protocol television (IPTV) system illustrated in FIG. 2. The portal server 302 communicates with a wireless device 352 via a wireless network 350. The portal server 302 can communicate with the wireless network 350 directly or via other network elements at the VHE 370. The wireless device 352 can include a cellular phone, a personal data assistant, a digital music player, another wireless device, or any combination thereof. The wireless network 350 can comprise a cellular network or other wireless network. The video head-end 370 also communicates with a set-top box device 380 via a video distribution network 390, such as an IPTV access network. The set-top box device 380 and the wireless device 352 can be associated with a media service subscriber.

The portal server 302 includes processing logic 304 and memory 306 accessible to the processing logic 304. The memory 306 includes a plurality of modules 322-332 that are adapted to enable the portal server 302 to perform various functions with respect to delivering content related to a media channel to a wireless device. In a particular embodiment, the modules 322-332 can include computer instructions that are readable and executable by the processing logic 304, such as instructions associated with one or more software applications, operating systems, other computer programs, or any combination thereof. In other embodiments, the modules 322-332 can include hardware logic or a combination of hardware logic and computer instructions.

The memory 306 includes a portal module 322 that is executable by the processing logic 304 to provide a web portal that is accessible to the wireless device 352. The web portal can comprise, for example, a wireless access protocol (WAP) site or other website accessible via a cellular phone or other wireless device. The memory 306 also includes a device communication module 324 that is executable by the processing logic 304 to communicate with the wireless device 352 to receive a request to access the web portal.

In addition, the memory 306 includes a device identification module 326 that is executable by the processing logic 304 to identify the wireless device 352 and a user associated with the wireless device 352, such as a media service subscriber. In an illustrative embodiment, the device identification module 326 is executable by the processing logic 304 to receive caller identification information, an Internet protocol address, other identifying information, or any combination thereof, from the wireless device 352 and to identify the user based on the identifying information received from the wireless device 352. In another example, the device identification module 326 can be executable by the processing logic 304 to receive login information from a user of the wireless device 352 and to identify the subscriber based on the login information. The device identification module 326 can be executable by the processing logic 304 to query another network element for account information associated with the wireless device 352, in order to identify the subscriber. In one embodiment, the device identification module 326 can be executable by the processing logic 304 to determine whether the subscriber is authorized to access the web portal based on identification information related to the wireless device 352, login information, or a combination thereof.

The memory 306 includes a channel identification module 328 that is executable by the processing logic 304 to receive data identifying a channel currently received at a set-top box device associated with the user, such as the set-top box 380. Data identifying the channel can be received from a media server, a subscriber history server, a distribution server (D-server), or another network element at the VHE 370. The channel identification module 328 is also executable by the processing logic 304 to receive data indicating a new channel when the set-top box device 380 issues a channel change request. In a particular embodiment, the channel identification module 328 is executable by the processing logic 304 to query a media server or other server to determine a channel being received at the set-top box device 380. In another embodiment, the media server or other server can automatically send data to the portal server 302 indicating a new selected channel at the set-top box device 380.

The memory 306 includes an information module 330 that is executable by the processing logic 304 to send content related to a media channel to the wireless device 352 in response to a request to access the web portal. In one embodiment, the information module 330 can store the related content. Further, the information module 330 can be executable by the processing logic 304 to select the related content based on historical information associated with the subscriber. In other embodiments, the information module 330 is executable by the processing logic 304 to retrieve the related content from an information server or other network element. The information module 330 is executable by the processing logic 304 to send new content related to a new channel after receiving data indicating that the set-top box device 380 has tuned to the new channel.

The memory 306 includes a data module 332 that is executable by the processing logic 304 to receive data from the wireless device 352. For instance, the content sent to the wireless device 352 can be interactive, and a user can send data to the portal server 302 via the wireless device 352 in the course of interacting with the content. One example of interactive information includes an interface to vote for television program contestants or to respond to a survey. The data module 332 is executable by the processing logic 304 to aggregate data received from the wireless device with similar data and to send the aggregated data to another server or network element that is adapted to send the aggregated data to the set-top box device 380.

In one embodiment, the content sent by the portal server 302 to the wireless device 352 can suggest programming associated with another channel and can include a selectable indicator of an option to receive the programming at the set-top box device 380. The data module 332 can be executable by the processing logic 304 to receive a selection of the indicator and to send data indicating the selection of the indicator to a D-server, a media server, the OSS/BSS gateway 244, or another network element of the VHE 370 that is adapted to send the programming associated with the other channel to the set-top box device 380. Additionally, the information module 330 is executable by the processing logic 304 to send content related to the other channel to the wireless device 352.

The wireless device 352 includes processing logic 354 and memory 356 that is accessible to the processing logic 354. The wireless device 352 also includes a display 310 and a network interface 358. The memory 356 includes a plurality of modules 360, 362 that are adapted to enable the wireless device 352 to perform various functions with respect to receiving content related to a media channel. In a particular embodiment, the modules 360, 362 can include computer instructions that are readable and executable by the processing logic 354, such as instructions associated with one or more software applications, operating systems, other computer programs, or any combination thereof. In other embodiments, the modules 360, 362 can include hardware logic or a combination of hardware logic and computer instructions.

The memory 356 includes a web module 360 that is executable by the processing logic 354 to receive an input indicating a command to access the web portal provided by the portal server 302. The web module 360 is executable by the processing logic 354 to send an access request to the portal server 302 and to receive, in response to the request, content related to a media channel. The web module 360 is executable by the processing logic 354 to display the related content via the display 310. In addition, the wireless device 352 can receive additional content related to the media channel, or content related to a new channel to which the set-top box device 380 has been tuned. The web module 360 is executable by the processing logic 354 to refresh the display 310 to display the new content in place of, or together with, content previously displayed at the wireless device 352.

Further, the memory 356 includes a data module 362 that is executable by the processing logic 354 to receive inputs related to interactive content displayed at the wireless device 352. For example, the data module 362 can be executable by the processing logic 354 to receive inputs to vote for a television program contestant or to purchase a DVD related to media content received at the set-top box device 380. The data module 362 is executable by the processing logic 354 to send data related to such inputs to the portal server 302.

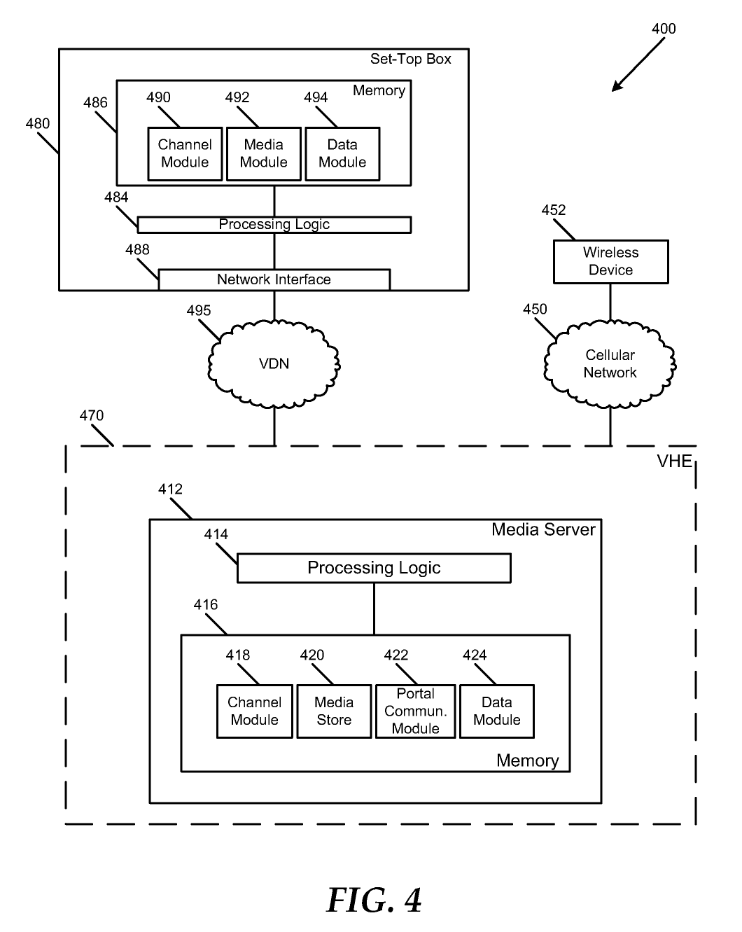

FIG. 4 illustrates a fourth particular embodiment of a system 400 to deliver content related to a media channel to a wireless device. The system 400 includes a media server 412 associated with a video head-end (VHE) 470 of a video distribution system, such as the Internet protocol television (IPTV) system illustrated in FIG. 2. The VHE 470 communicates with a wireless device 452 via a wireless network 450. The VHE 470 also communicates with a set-top box device 480 via a video distribution network 495, such as an IPTV access network. In one embodiment, the media server 412 can communicate with the video distribution network 495 directly or via other network elements at the VHE 470. The set-top box device 480 and the wireless device 452 can be associated with a media service subscriber.

The media server 412 includes processing logic 414 and memory 416 accessible to the processing logic 414. The memory 416 includes a plurality of modules 418-424 that are adapted to enable the media server 412 to perform various functions with respect to delivering content related to a media channel to a wireless device. In a particular embodiment, the modules 418-424 can include computer instructions that are readable and executable by the processing logic 414, such as instructions associated with one or more software applications, operating systems, other computer programs, or any combination thereof. In other embodiments, the modules 418-424 can include hardware logic or a combination of hardware logic and computer instructions.

The memory 416 includes a channel module 418 that is executable by the processing logic 414 to receive a media channel selection from the set-top box device 480. The memory 406 includes a media store 420 that stores media related to at least one media channel. The channel module 418 can be executable by the processing logic 414 to send media related to the requested channel to the set-top box device 480.

The memory 416 includes a portal communication module 422 that is executable by the processing logic 414 to send data identifying the channel to a portal server at the VHE 470. The portal server is adapted to send content related to the media channel to the wireless device 452. The portal communication module 418 can be executable by the processing logic 414 to send the data identifying the channel to the portal server automatically or in response to a query from the portal server. In an illustrative embodiment, the memory 416 can include a data module 424 that is executable by the processing logic 414 to receive data from the portal server related to the content sent to the wireless device 452. The data module 424 can be executable by the processing logic 414 to send the data to the set-top box device 480 to be displayed with media content associated with the channel being received at the set-top box device 480.

The set-top box device 480 includes processing logic 484 and memory 486 accessible to the processing logic 484. The set-top box device 480 also includes a network interface 488 that is adapted to facilitate communication between the set-top box device 480 and the video distribution network 495. The memory 486 includes a plurality of modules 490-494 that are adapted to enable the set-top box device 480 to perform various functions with respect to delivering content related to a media channel to a wireless device. In a particular embodiment, the modules 490-494 can include computer instructions that are readable and executable by the processing logic 484, such as instructions associated with one or more software applications, operating systems, other computer programs, or any combination thereof. In other embodiments, the modules 490-494 can include hardware logic or a combination of hardware logic and computer instructions.

The memory 486 includes a channel module 490 that is executable by the processing logic 484 to send data indicating a channel selection to the video head-end 470. The memory 486 includes a media module 492 that is executable by the processing logic 484 to receive media content associated with the media channel. Further, the memory 486 includes a data module 494 that is executable by the processing logic 484 to receive data from the VHE 470, where the data is output by a portal server based at least partially on data received from the wireless device 452. The data module 494 is executable by the processing logic 484 to send the data to a display device coupled to the set-top box device 480 together with the media content. In an illustrative embodiment, the data can be displayed above the media content, below the media content, in a sidebar, in an L-bar, scrolling near a border of the media content, or in another data display area.

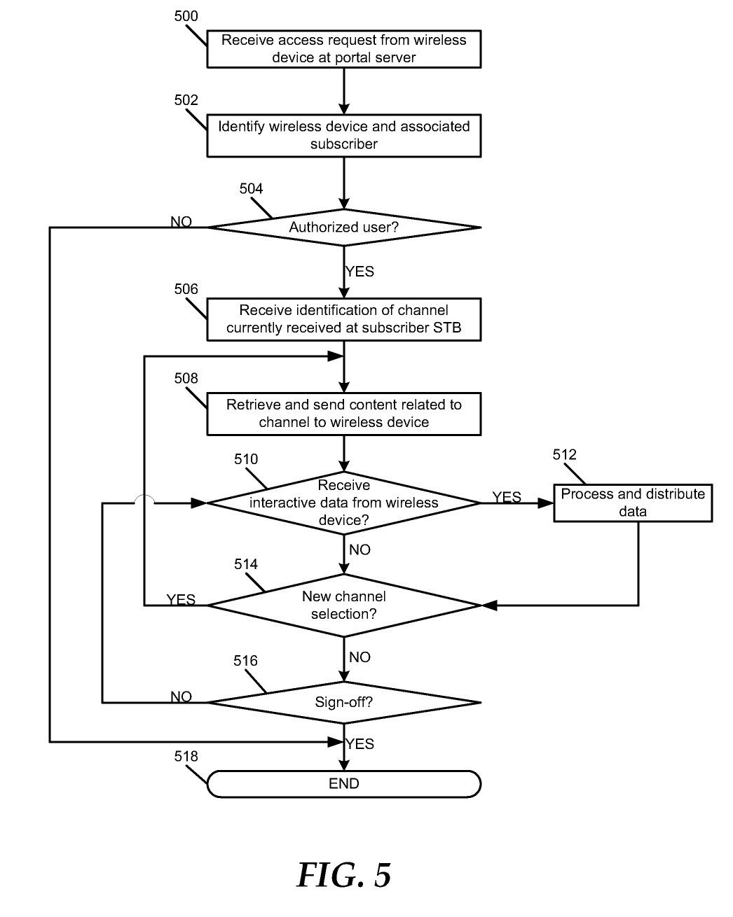

FIG. 5 illustrates a particular embodiment of a method of delivering content related to a media channel to a wireless device. At block 500, a portal server receives a request from a wireless device to access a web portal. Moving to block 502, the portal server identifies the wireless device and a media service subscriber associated with the wireless device. Proceeding to decision node 504, the portal server determines whether the subscriber is authorized to access the web portal. If the subscriber is not an authorized user, the method terminates at 518.

Conversely, if the subscriber is an authorized user, the method continues to block 506, and the portal server receives data from a media server or other network element indicating a media channel (e.g., a video channel or music channel) currently received at a set-top box device associated with the subscriber. In one embodiment, the set-top box device can be one of a plurality of set-top box devices at the subscriber's premises, and the subscriber can be logged in at the set-top box device or can otherwise be associated with the particular set-top box device through prior configuration.

Advancing to block 508, the portal server retrieves and sends content related to the media channel to the wireless device. The portal server can retrieve the related content from memory or from one or more information servers communicating with the portal server at a video head-end. At decision node 510, the portal server determines whether it has received data from the wireless device indicating inputs corresponding to the content related to the media channel. Such inputs may include, for example, a vote for a video program contestant, a selection to purchase a product, other inputs, or any combination thereof.

If the portal server does not receive such data from the wireless device, the method proceeds to decision node 514. Whereas, if the portal server has received such data, the method moves to block 512, and the portal server processes and distributes the data. For example, if the data includes a vote for a television program contestant, the portal server can aggregate the vote with other votes and send the aggregated votes to a voting server, media server, other network element, or any combination thereof.

Proceeding to decision node 514, the portal server determines whether it has received data indicating a new channel selection. In one embodiment, the data can indicate a new channel selection at the set-top box device associated with the subscriber.

In another embodiment, the content sent by the portal server to the wireless device can include a selectable indicator of an option to receive other programming at the set-top box device, and the data indicating the new channel selection can comprise data received from the wireless device indicating a selection of the indicator.

If the portal server receives data indicating a new channel selection, the method returns to block 508, and the portal server retrieves and sends content related to the new channel to the wireless device. If the portal server does not receive indicating a new channel selection, the method continues to decision node 516, and the portal server determines whether the wireless device has signed off from the web portal. If the portal server receives data indicating that the wireless device has signed off from the web portal, the method terminates at 518.

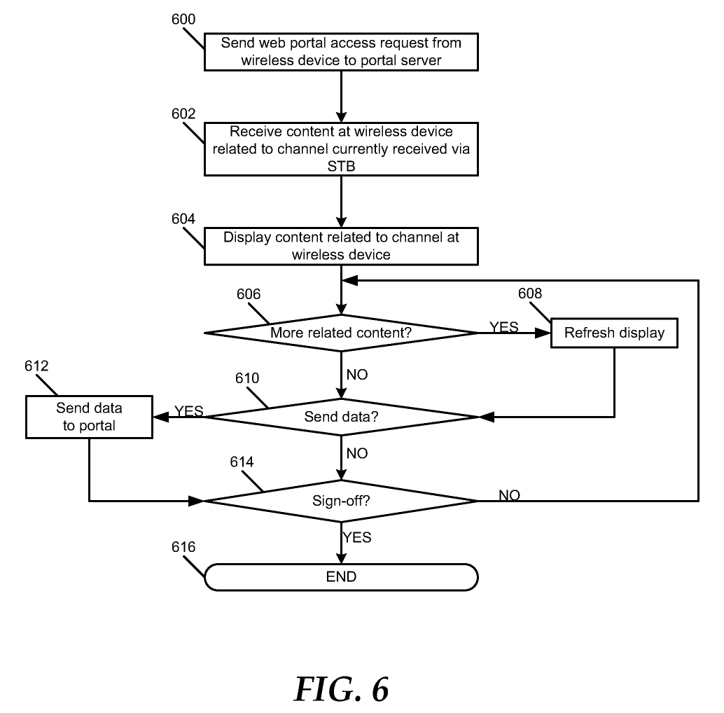

FIG. 6 illustrates a second particular embodiment of a method of delivering content related to a media channel to a wireless device. At block 600, a wireless device sends a request to access a web portal to a portal server at a video head-end of a video distribution system. Moving to block 602, the wireless device receives content via the web portal, where the content is related to a media channel currently being received at a set-top box device associated with a user of the wireless device. Proceeding to block 604, the wireless device displays the content related to the media channel.

Continuing to decision node 606, the wireless device determines whether it has received additional content related to the channel or to a new channel to which the set-top box device has been tuned. If the wireless device has not received additional content, the method advances to decision node 610. On the other hand, if the wireless device receives additional content, the method moves to block 608, and the wireless device refreshes its display to display the additional content in place of, or together with, the information displayed at block 604. The method then advances to decision node 610.

At decision node 610, the wireless device determines whether it has received data related to the content displayed at the wireless device. If the wireless device does not receive such data, the method proceeds to decision node 614. Conversely, if the wireless device receives data related to the content, the method moves to block 612, and the wireless device sends the data to the portal server via the web portal. Proceeding to decision node 614, the wireless device determines whether it has received a command to sign-off from the web portal. If the wireless device does not receive such a command, the method can return to decision node 606. If the wireless device receives a sign-off command, the method terminates at 616.

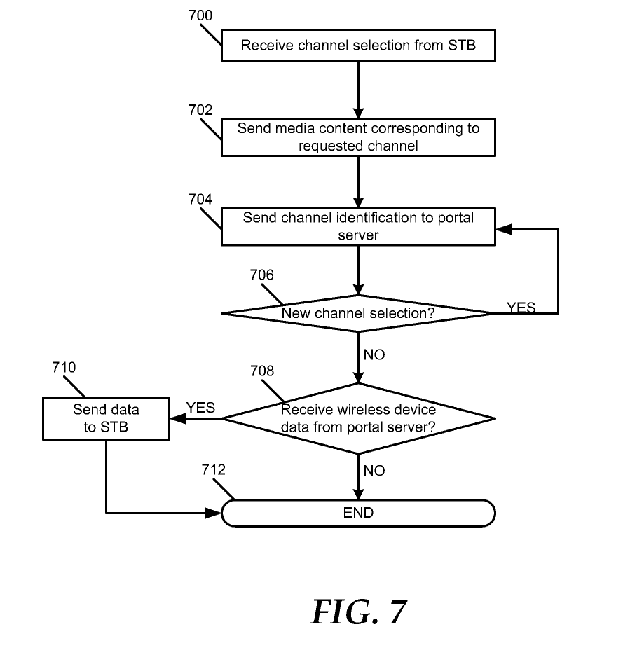

FIG. 7 illustrates a third particular embodiment of a method of delivering content related to a media channel to a wireless device. At block 700, a video head-end device, such as a media server, distribution server, switch, or other device, receives a media channel selection from a set-top box device associated with a user. Moving to block 702, the video head-end device sends media content related to the requested channel to the set-top box device. Proceeding to block 704, the video head-end device sends data identifying the channel to a portal server. The portal server is adapted to send content related to the media channel to a wireless device associated with the user. The video head-end device can send the data identifying the channel to the portal server automatically or in response to a query from the portal server.

Continuing to decision node 706, the video head-end device determines whether it has received a new channel selection from the set-top box device. If the video head-end device has received a new channel selection from the set-top box device, the method returns to block 704, and the video head-end device sends data identifying the new channel to the portal server. Conversely, if the video head-end device has received a new channel selection from the set-top box device, the method advances to decision node 708, and the video head-end device determines whether it has received data from the portal server, where the data is output by the portal server based on data received from a wireless device associated with the user. In a particular embodiment, if the video head-end device receives such data, the video head-end device can send the data to the set-top box device to be displayed with media content associated with the channel being received at the set-top box device. The method terminates at 712.

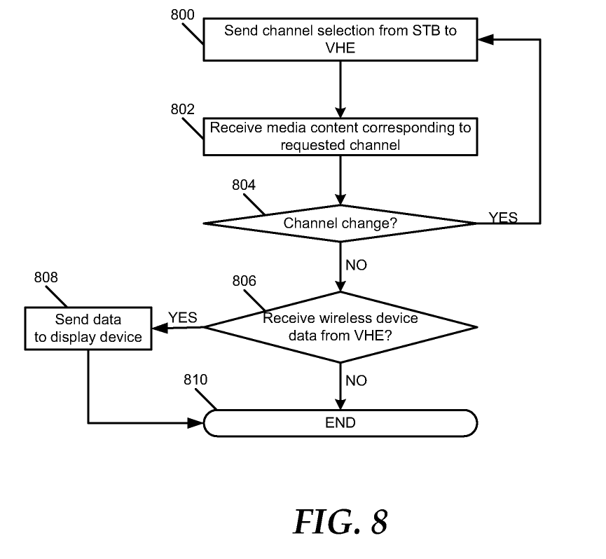

FIG. 8 illustrates a fourth particular embodiment of a method of delivering content related to a media channel to a wireless device. At block 800, a set-top box device associated with a user sends a channel selection to a video head-end of a video distribution system. Moving to block 802, the set-top box device receives media content associated with the media channel from the video head-end. The media content may include audio, video, or a combination thereof. Proceeding to decision node 804, the set-top box device determines whether it has received a channel change command. If the set-top box device has received a channel change command, the method returns to block 800, and the set-top box device sends a new channel selection to the video head-end.

Conversely, if the set-top box device has not received a channel change command, the method continues to decision node 806, and the set-top box device determines whether it has received data from the video head-end, where the data is output by a portal server based on data received from a wireless device associated with the user. In a particular embodiment, if the set-top box device receives such data, the method advances to block 808, and the set-top box device sends the data to a display device coupled to the set-top box device. The method terminates at 810.

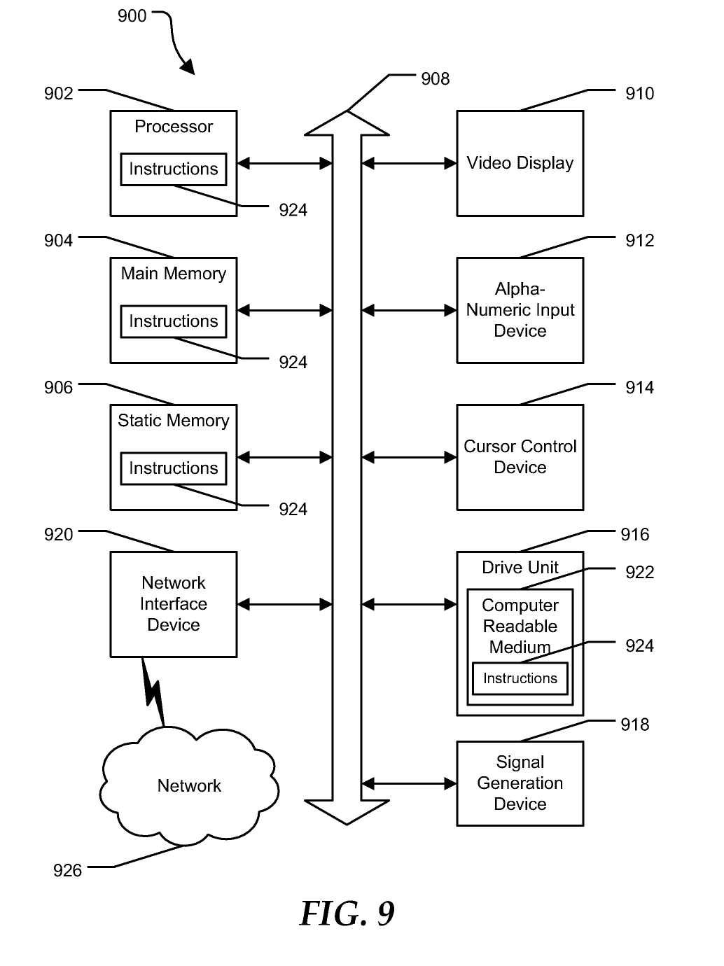

FIG. 9 shows an illustrative embodiment of a general computer 900 including a set of instructions that can be executed to cause the computer system to perform any one or more of the methods or computer based functions disclosed herein. The computer system 900 may operate as a standalone device or may be connected, e.g., using a network, to other computer systems or peripheral devices. In an illustrative embodiment, such standalone and peripheral devices can include, for example, media servers, portal servers, wireless devices, set-top box devices, switches, other network elements associated with an Internet protocol television system, or any combination thereof, as illustrated in FIGS. 1-4.

In a networked deployment, the computer system may operate in the capacity of a server or as a client user computer in a server-client user network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 900 can be implemented using electronic devices that provide voice, video, audio or data communication. Further, while a single computer system 900 is illustrated, the term “system” shall also be taken to include any collection of systems or sub-systems that individually or jointly execute a set, or multiple sets, of instructions to perform one or more computer functions.

The computer system 900 may include a processor 902, e.g., a central processing unit (CPU), a graphics processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid state display, or a cathode ray tube (CRT). Additionally, the computer system 900 may include an input device 912, such as a keyboard, and a cursor control device 914, such as a mouse. The computer system 900 can also include a disk drive unit 916, a signal generation device 918, such as a speaker or remote control, and a network interface device 920.

In a particular embodiment as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media. The network interface device 920 can provide connectivity to a network 926, e.g., a wide area network (WAN), a local area network (LAN), or other network.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 926 can communicate voice, video, audio or data over the network 926. Further, the instructions 924 may be transmitted or received over the network 926 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method of delivering content related to a media channel to a wireless device, the method comprising:
receiving a request to access a web portal, the request received from a wireless device at a portal server associated with a video distribution network;
receiving data at the portal server from a network element associated with the video distribution network, the data indicating a media channel associated with media content currently received at a set-top box device, wherein the set-top box device and the wireless device are associated with a media service subscriber; and
automatically sending content related to the media channel to the wireless device via the web portal, in response to the access request.

2. The method of claim 1, further comprising identifying the wireless device and identifying the media service subscriber based on an identification of the wireless device.

3. The method of claim 2, further comprising receiving information identifying the wireless device, login information, or any combination thereof.

4. The method of claim 3, wherein information identifying the wireless device includes an Internet protocol (IP) address associated with the wireless device, caller identification information, or a combination thereof.

5. The method of claim 1, wherein the data indicating the media channel is received from a media server associated with the media channel.

6. The method of claim 1, wherein the media content includes video content, audio content, information content, or any combination thereof.

7. A system to deliver content related to a media channel to a wireless device, the system comprising:
a portal server associated with a video head-end of a video distribution system, the portal server including processing logic and memory accessible to the processing logic, wherein the memory includes instructions executable by the processing logic to:
receive a request to access a web portal from a wireless device;
receive data indicating a media channel associated with media content currently received at a set-top box device, wherein the set-top box device and the wireless device are associated with a media service subscriber; and
automatically send content related to the media channel to the wireless device via the web portal, in response to the access request.

8. The system of claim 7, wherein the content related to the media channel is stored at the memory.

9. The system of claim 7, wherein the memory includes instructions executable by the processing logic to retrieve the content related to the media channel from an information server at the video head-end.

10. The system of claim 7, wherein the content related to the media channel is selected based on historical information associated with the subscriber.

11. The system of claim 7, wherein the memory includes instructions executable by the processing logic to send a request to a network element at the video head-end for the data indicating the media channel.

12. The system of claim 7, wherein the memory includes instructions executable by the processing logic to receive data at the portal server indicating a new media channel and automatically sending content related to the new media channel to the wireless device.

13. A system to deliver content related to a media channel to a wireless device, the system comprising:
a wireless device having processing logic and memory accessible to the processing logic, wherein the memory includes instructions executable by the processing logic to:
send a request to a portal server to access a web portal;
receive, in response to the request, content related to a media channel associated with media content received at a set-top box device, wherein the set-top box device and the wireless device are associated with a media service subscriber; and
output the content related to the media channel via a display portion of the wireless device.

14. The system of claim 13, wherein the memory includes instructions executable by the processing logic to receive additional content at the wireless device and to output the additional content via the display portion.

15. The system of claim 15, wherein the memory includes instructions executable by the processing logic to refresh a display at the display portion to include the additional content.

16. The system of claim 15, wherein the additional content is related to a new channel associated with new media content received at the set-top box device.

17. The system of claim 13, wherein the wireless device includes a cellular phone, a personal data assistant, a digital music player, or any combination thereof.

18. A computer-readable medium including processor-readable instructions executable by a processor to perform a method, the method comprising:
receiving a request to access a web portal, the request received from a wireless device at a portal server associated with a video head-end of a video distribution system;
receiving data at the portal server indicating a media channel associated with media content currently received at a set-top box device, wherein the set-top box device and the wireless device are associated with a media service subscriber; and
automatically sending content related to the media channel to the wireless device via the web portal, in response to the access request.

19. The computer-readable medium of claim 18, wherein the content related to the media channel includes interactive content, and wherein the method further comprises receiving data from the wireless device, wherein the data corresponds to inputs received at the wireless device in response to the interactive data.

20. The computer-readable medium of claim 19, wherein the method further comprises processing the data and sending processed data related to the inputs to a network element at the video head-end, wherein the network element is adapted to send information content corresponding to the processed data to the set-top box device.

21. The computer-readable medium of claim 19, wherein the interactive data includes a selectable indicator of an option to select a new channel and wherein the method further comprises receiving data from the wireless device indicating a selection of the indicator and automatically sending content related to the new channel to the wireless device in response to the data indicating the selection of the indicator.

22. The computer-readable medium of claim 21, wherein the method further comprises sending data to a media server at the video head-end, wherein the media server is adapted to send media content related to the new channel to the set-top box device.

23. A computer-readable medium including processor-readable instructions executable by a processor to perform a method, the method comprising:
sending a request from a wireless device to a portal server to access a web portal;
receiving, in response to the request, content related to a media channel associated with media content received at a set-top box device, wherein the set-top box device and the wireless device are associated with a media service subscriber; and
outputting the content related to the media channel via a display portion of the wireless device.

24. The computer-readable medium of claim 23, wherein the content related to the media channel includes content related to the media channel, content related to the media content received at the set-top box device, or a combination thereof.

25. The computer-readable medium of claim 23, wherein the content related to the media channel includes a suggestion of other media content, content related to a video program, song, collection of songs, or other media currently received at the set-top box device, video-on-demand information related to media content being received at the set-top box device, targeted advertising information, a link to purchase a product related to the media content, historical content, surveying content related to the media content, or any combination thereof.
